(19) United States
(12) Patent Application Publication
(10) Pub. No.: US 2004/0216794 A1
(43) Pub. Date: Nov. 4, 2004

(54) Expandable plug and method of manufacture

(76) Inventors: Thomas J Beckey, Edina, MN (US); David A. Endresen, Brooklyn Center, MN (US)

Correspondence Address: Anthony G Eggink, 3100 First National Bank Building, 332 Minnesota Street, St Paul, MN, 55101, US

(21) Appl. No.: 10/489,124

(22) PCT Filed: Dec. 4, 2002
(86) PCT No.: PCT/US02/38678

Related U.S. Application Data
(60) Provisional application No. 60/337,203, filed on Dec. 4, 2001.

(51) Int. Cl. F16L 55/12

(52) U.S. Cl. 138/93; 138/89; 138/90

(57) ABSTRACT

An expandable plug device and a method for manufacturing the expandable plug. The expandable plug device has a sacrificial core which is used as an interior mold in the manufacturing process and which remains in the plug body after completion and during use. The expandable plug device is a multi-size plug having elastomeric and reinforcing layers and which may have an internal fluid flow-through conduit.

### BACKGROUND OF THE INVENTION

This application claims the benefit of U.S. Provisional Application No. 60/337,203 filed on Dec. 4, 2001.

This invention relates generally to an expandable plug structure and a method of manufacturing expandable plugs. Particularly, this invention relates to a method whereby an expandable plug is constructed and manufactured on a sacrificial core or inner mold which remains within the cavity of the plug body upon completion of the plug structure. The method utilizes an outer mold which is removed from the plug structure subsequent the curing or vulcanization of the layered and reinforced elastomeric plug body.

The expandable plugs of the invention may be multi-size pneumatic plugs which are constructed and arranged to be inflated and used to seal interior portions of pipelines, having a specified diameter range, for repair and construction purposes. Pneumatic plugs are known and, for example, a plug structure is disclosed in U.S. Pat. No. 5,379,802. The complexity of the plug and the difficulty of manufacture are shown therein regarding use of a mandrel. Pneumatic plugs adapted for use in a range or multi-size pipeline diameters are also disclosed in U.S. Pat. No. 4,614,206 and wherein plug sleeve structures are mounted on rigid end support members. The disclosure of the '206 patent is incorporated by reference herein. This prior art shows the difficulty of the manufacture of multi-size pneumatic plugs.

The invention particularly relates to a method of manufacturing expandable plugs including multi-size pneumatic plugs for use in 4-8 inch (10.16-20.32 cm), 8-16 inch (20.32-40.64 cm), 12-24 inch (30.48-60.96 cm) and 24-48 inch (60.96-121.92 cm) ID pipes. The pneumatic plugs are preferably constructed of layered and reinforced elastomeric materials, have an inflator member and may comprise metal end plates, and may further have a flow-through conduit. Importantly, a sacrificial core structure or inner mold is used in the manufacturing method and which remains in the plug after completion. However, the core does not become an integral part in the use of the completed plug structure.

The prior art does not disclose an expandable plug which utilizes a sacrificial inner mold or core structure on which elastomeric materials are placed and formed and wherein the core is subsequently separated to produce a pneumatic plug in which the core remains.

The pneumatic plug manufacturing method of the present invention provides an improved manufacturing process which is more efficient and economical than the manufacturing methods presently used in the art of manufacturing pneumatic plugs.

### SUMMARY OF THE INVENTION

The present invention relates to an expandable plug structure and a method of manufacturing expandable plugs. The invention specifically relates to multi-size pneumatic plug structures having a sacrificial inner core structure, and to the method of manufacture of such plugs. The expandable plugs, such as pneumatic plugs, are preferably constructed of a multi-layered, reinforced elastomeric cylindrical body, i.e., of reinforced natural rubber, and having an inflator member at one end. The multi-layers include various rubber layers, rubber coated Kevlar and biaxial nylon cording which subsequent vulcanization provide a unitary plug with shoulders that resist delamination. The cylindrical body may incorporate metal end plates as well as end plate weldment structures which cooperate with a flow-through conduit which allows the completed pneumatic plug to simultaneously seal a pipeline and to direct fluid therethrough. Importantly, a sacrificial core or inner mold structure is used in the manufacturing method and the core remains within the plug body after completion. The sacrificial core or inner mold does not become an integral part of the use of the completed pneumatic plug structure.

The process of manufacture includes the following steps. First, a sacrificial core structure, formed of a cardboard tube or the like, having a specified O.D. is cut to a specified length; end plates, with or without an internal bypass, are positioned onto the core ends to thereby form an inner mold; next, the inner mold (core structure and plates) is wrapped with layers of an elastomeric material such as natural rubber sheets and reinforcement cording, up to a specified thickness; the body of rubber layers is next secured by an outer mold, such as a metal mold or a wrapped nylon tape which shrinks, i.e., 3% when subjected to heat to provide a flexible outer mold; the molded and wrapped structure is then placed in an oven for a specified period of time to cure or vulcanize the natural rubber compound; the exterior mold or tape is then removed from the cured plug body; an inflator member is provided and the plug body is then inflated to separate the rubber plug body from the core or inner mold; and the plug is then deflated and forces are applied to the outside of the plug body directed at the core to crush and further separate the rubber plug body from the inner core structure to thereby provide the finished plug structure.

These and other benefits of this invention will become apparent from the following description by reference to the drawings.

### BRIEF DESCRIPTION OF THE DRAWINGS

FIG. 1 is a perspective view of the expandable plug device of the present invention;

FIG. 2 is a lateral plan view of the expandable plug device;

FIG. 3 is a sectional plan view of the expandable plug device;

FIG. 4 is a partial sectional view showing the plug body of the expandable plug device;

FIG. 5 is another partial sectional view of the expandable plug device and showing the opposite end of the plug body;

FIG. 6 is a partial sectional view of another embodiment of the expandable plug device and showing the plug body;

FIG. 7 is another partial sectional view of the expandable plug device of FIG. 6;

FIG. 8 is a sectional plan view of another embodiment of the expandable plug device of the present invention;

FIG. 9A is a perspective view of the expandable plug of FIG. 8;

FIG. 9B is a perspective view of another embodiment of the expandable plug of FIG. 8;

FIG. 10 is an exploded view showing the expandable plug of FIGS. 8 and 9A; and

FIGS. 11-18 show the process steps used in the manufacture of the expandable plug device of the present invention.

### DESCRIPTION OF THE PREFERRED EMBODIMENTS

The present invention relates to an expandable plug device having fluid ingress and egress means. For example, a fluid, a liquid or a gas may be used to inflate and deflate the plug body which is typically cylindrical in structure but which may have other shapes or configurations. A pneumatic plug is expandable utilizing air, and an inflator assembly, such as a valve, may be used for the ingress and egress of air under pressure. A pneumatic plug will be used herein to describe the present invention. Importantly, the expandable plug device and method of manufacture include the use of a sacrificial core structure. The sacrificial core may be crushable, deformable, shatterable, melted or otherwise deformed or dissipated subsequent its use to form the plug in manufacture. For example, a cardboard or plastic tube may be used as the sacrificial core structure of the invention, however, a cardboard tube will be used for purposes of describing the present invention.

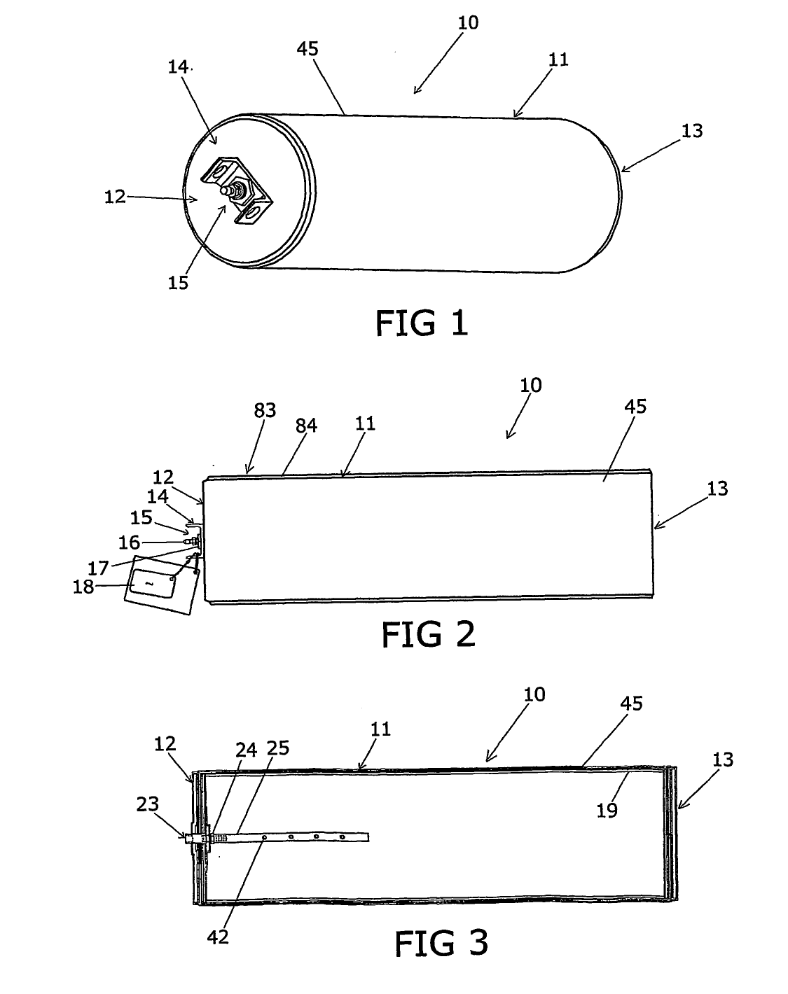

Referring to FIGS. 1-3, the expandable or pneumatic plug 10 is shown to have a cylindrical body 11, an inflation end 12 and a closed end 13. A tether assembly 14 and inflator assembly 15 is shown at the inflation end 12 of the pneumatic plug 10. The inflator assembly 15 has an inflation valve 16, secured by locknut 17, and which is utilized to inflate and deflate the plug body 11. The tether assembly 14 is shown to have a pair of apertures which are designed to receive tether members (not shown) to move the plug in a pipeline and/or to receive an informational tag 18, for example. Tether members typically are rigid structures, i.e., metallic, which pivot within the apertures of the assembly 14 and are constructed and arranged to receive a tether line, for example, to move and position the plug.

The pneumatic plug 10 may be used for various pipeline sealing and repair operations. Typically, the plug 10 is used to seal a pipeline to block fluid flow, however, in FIG. 2 the plug 10 is shown to have an outside layer 83 disposed about the periphery of the cylindrical body 11. The layer 83 is an absorbent structure, i.e., felt or the like, impregnated with a curable sealant 84, i.e., an epoxy or the like, for repairing a pipeline crack, for example. The plug 10 in this case is utilized as a carrier structure for positioning adjacent the pipeline crack. For repair, the plug 10 is expanded and the sealant 84 impregnated layer 83 is forced against the previously cleaned pipeline interior surface. Upon plug 10 deflation and removal, the layer 83 remains in the pipeline and the sealant 84 is cured to seal and repair the pipeline crack.

Referring particularly to FIG. 3, the cylindrical body 11 is shown to have a sacrificial core 19, such as a cylindrical tube, about which a reinforced layered elastomeric body 45 is placed. The cylindrical tube 19 may be constructed of a Kraft cardboard and for a 12-24 inch (30.48-60.96 cm) plug may have an inside diameter of 10 inches (25.4 cm) and a 0.125 inch (0.3175 cm) wall thickness, for example. At the ends of the cylindrical tube 19, the opposing plug ends 12 and 13 are also shown to have a layered structure. Further, the inflator assembly 15 is shown to have a bulkhead structure 23 which extends into the pneumatic plug 10 and which is shown to have an adapter 24 with an internal hose 25 having apertures 42 attached thereto.

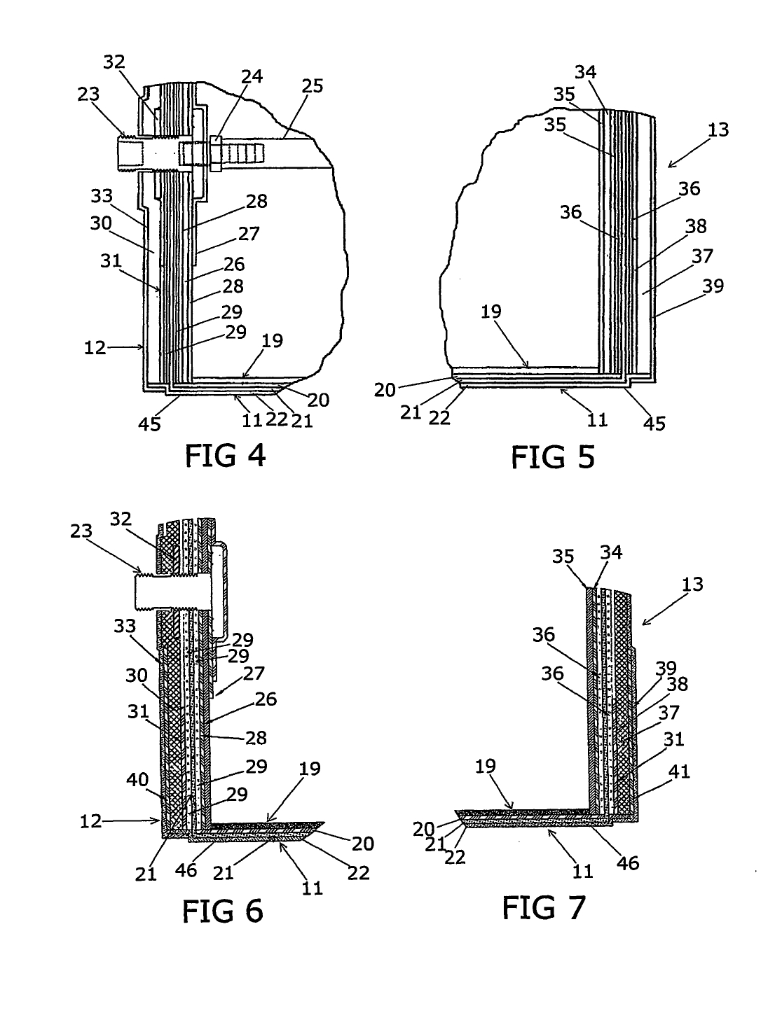

Referring to FIGS. 4 and 5, the layered structure 45 about cylindrical body 11 and the layered ends 12 and 13 are shown in detail. Importantly, the layered structure 45 of the pneumatic plug 10 is shown wrapped about the cylindrical tube 19 and abutting against the opposing ends of the tube 19. For example, the cylindrical tube 19 may be a cardboard tube structure having a diameter of 10.25 inches (26.035 cm) when making a pneumatic plug 10 for use in sealing 12-24 inch (30.48-60.96 cm) diameter pipelines. The layers shown wrapped about the periphery of the tube 19 are elastomeric layers 20, 21 and 22, which respectively may comprise a 0.085 inch (0.2159 cm) thick layer 20 of rubber, a 0.085 inch (0.2159 cm) thick layer 21 of rubber coated Kevlar cording, for example, and a 0.085 inch (0.2159 cm) layer 22 of soft rubber. The reinforced intermediate layer 21 is also shown to extend onto each end 12 and 13 of the pneumatic plug. As will be further described, the ends of layer 21 may have a plurality of tabs or flaps which when folded over the plug shoulders and onto the ends generally form a circular pattern on the plug body ends.

In FIG. 4, the inflation end 12 is shown to have a plurality of layers which from the outside to the inside of the plug are as follows: a 0.085 inch (0.2159 cm) layer 33 of a soft rubber in an annular or donut shape, a 0.265 inch (0.6731 cm) pad layer 30 of rubber, a 0.085 inch (0.2159 cm) layer 31 of rubber in a donut shape, a 0.060 inch (0.1524 cm) pad layer 29 of biaxial nylon (nylon fibers perpendicularly disposed to each other), the reinforced 0.085 inch (0.2159 cm) layer 21 of rubber coated Kevlar, a 0.060 inch (0.1524 cm) layer 29 of biaxial nylon, a 0.085 inch (0.2159 cm) pad layer 28 of rubber, a coated steel plate 26, a 0.085 inch (0.2159 cm) pad layer 28 of rubber and a 0.085 inch (0.2159 cm) pad layer 27 of rubber. The bulkhead 23 is shown secured within the inflation end 12 by means of threaded washer 32. At the opposite closed end 13 of the pneumatic plug, the layered structure from the outside to the inside of the plug is similar and is as follows: a 0.085 inch (0.2159 cm) layer 39 of a soft rubber, a 0.085 inch (0.2159 cm) layer 37 of a rubber donut, a 0.085 inch (0.2159 cm) layer 38 of a rubber donut, a 0.060 inch (0.1524 cm) pad layer of biaxial nylon 36, the 0.085 inch (0.2159 cm) layer 21 of rubber coated Kevlar, a 0.060 inch (0.1524 cm) pad layer of biaxial nylon 36, a 0.085 inch (0.2159 cm) pad layer 35 of rubber, a coated steel plate 34, and a 0.085 inch (0.2159 cm) pad layer 35 of rubber. The layered structure of the pneumatic plug as shown in FIGS. 4 and 5 is exemplary and alternate layered structures may also be utilized about the tube 19 as well as at the tube ends.

FIGS. 6 and 7 show an alternate layered embodiment 46 wherein the cylindrical body 11 layers and the layers at the ends 12 and 13 are similar to those shown and described with respect to FIGS. 4 and 5, however, several layers are different. For example, a 0.085 inch (0.2159 cm) layer 40 of a hard rubber is shown disposed between outer layer 33 and layer 30. Further, the outer layer at the closed end 13 is shown to comprise a 0.085 inch (0.2159 cm) layer 41 of a hard rubber donut.

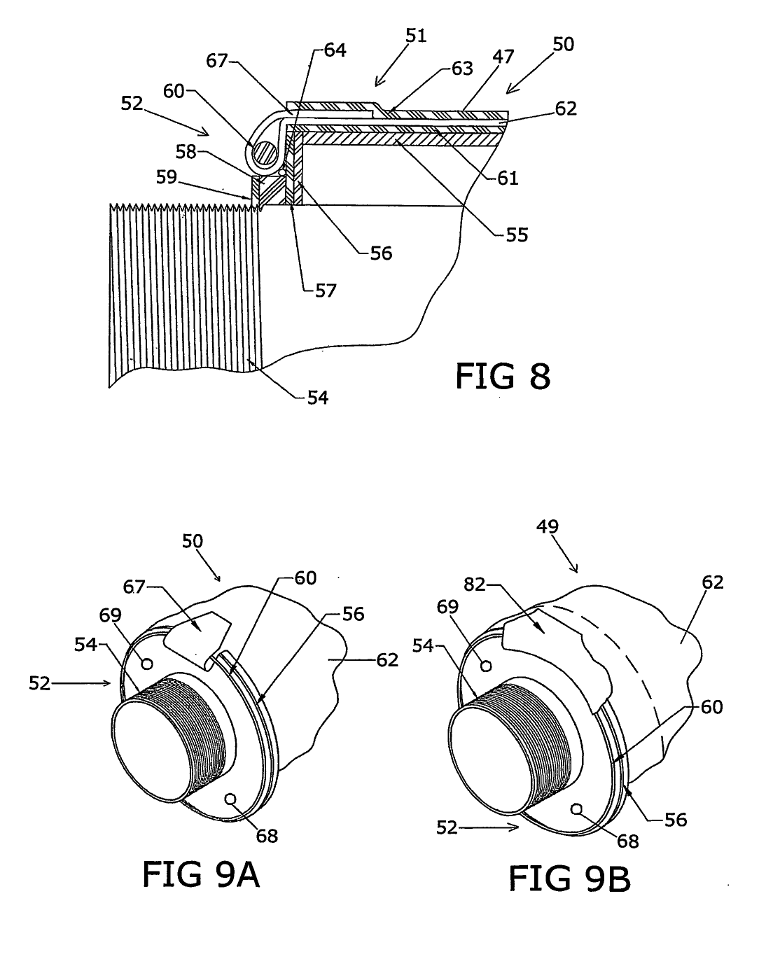

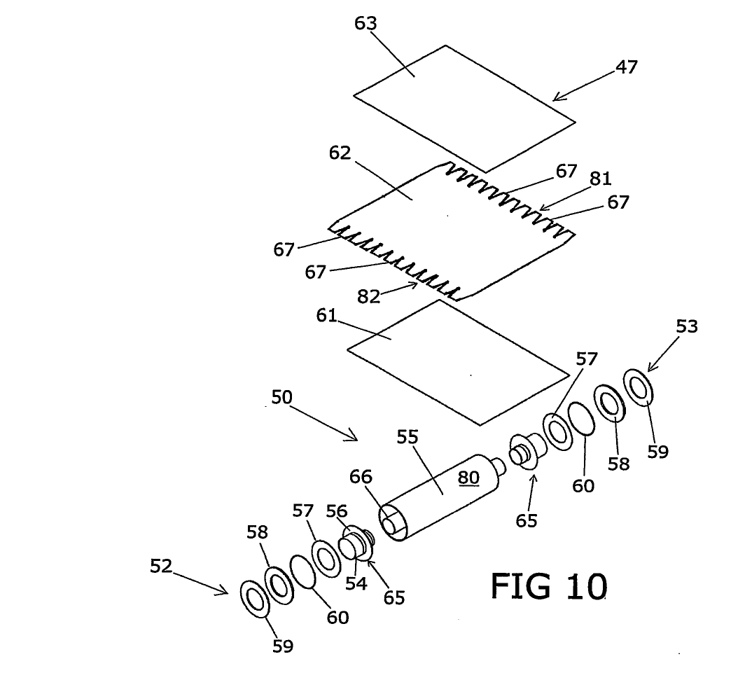

FIGS. 8-10 show an embodiment of the pneumatic plug 50, wherein an internal by-pass or fluid flow-through conduit is utilized. As shown, a bypass hose 66 is positioned in the interior of cardboard tube 55 and layers 61, 62 and 63 of the cylindrical body 51 are wrapped about the cardboard tube 55, which preferably has a rubber cement 80 thereon, to maintain the layers in place. Layer 61 may be 0.085 inch (0.2159 cm) layer of hard rubber, the second layer 62 may be a 0.085 inch (0.2159 cm) reinforced Kevlar rubber layer and the outside layer 63 a 0.085 inch (0.2159 cm) soft rubber layer. The reinforced layer 62 is shown in FIG. 10 to have a plurality of pleats or flaps 67, which in FIG. 9A are shown to be wrapped about a ring 60, i.e., a 5/16 inch (0.79375 cm) diameter steel ring. As shown in FIG. 8, the flaps 67 are folded into the layered body 47. A fill rubber piece 64 is further shown to be utilized adjacent layer 57 and above rubber layer 58. The flaps or pleats 67 of the corded layer 62 when wrapped around metal ring 60 and folded back into the plug body approximately four to five inches (10.16-12.7 cm) provides a unitary plug body subsequent vulcanization and provide plug shoulders which resist delamination.

The flow-through pneumatic plug embodiment 50 in FIGS. 8-10 is further shown to utilize an end plate weldment 65 at each plug end, namely, the inflation end 52 and the closed end 53, and which connect to the opposite ends of the bypass hose 66. Each end plate weldment 65 is shown comprised of an end or backing plate 56, i.e., a steel end plate, and a threaded pipe nipple 54. Adjacent the end plates 56 and over the nipple 54, the following layers or elements are shown: a 0.085 inch (0.2159 cm) rubber layer 56, the steel ring 60, a 0.265 inch (0.6731 cm) donut layer of rubber 58 and an outside 0.085 inch (0.2159 cm) donut layer 59 of hard rubber. The inflation end 52 in FIGS. 9A and 9B is also shown to have an aperture 68 to receive an inflation assembly as well as an aperture 69 to receive a tether assembly as discussed with respect to FIGS. 1 and 2.

FIG. 9B shows plug embodiment 49 with the end portion 82 of the reinforced layer 62 being wrapped about the ring 60 and folded back onto the plug body. The other elements of the embodiment 49 are similar to the plug embodiment 50 shown in FIGS. 8 and 9A. The end flaps 67 shown in FIG. 9A and the end portion 82 of layer 62 of FIG. 9B are each folded approximately four to five inches back onto layer 62 in the plug body.

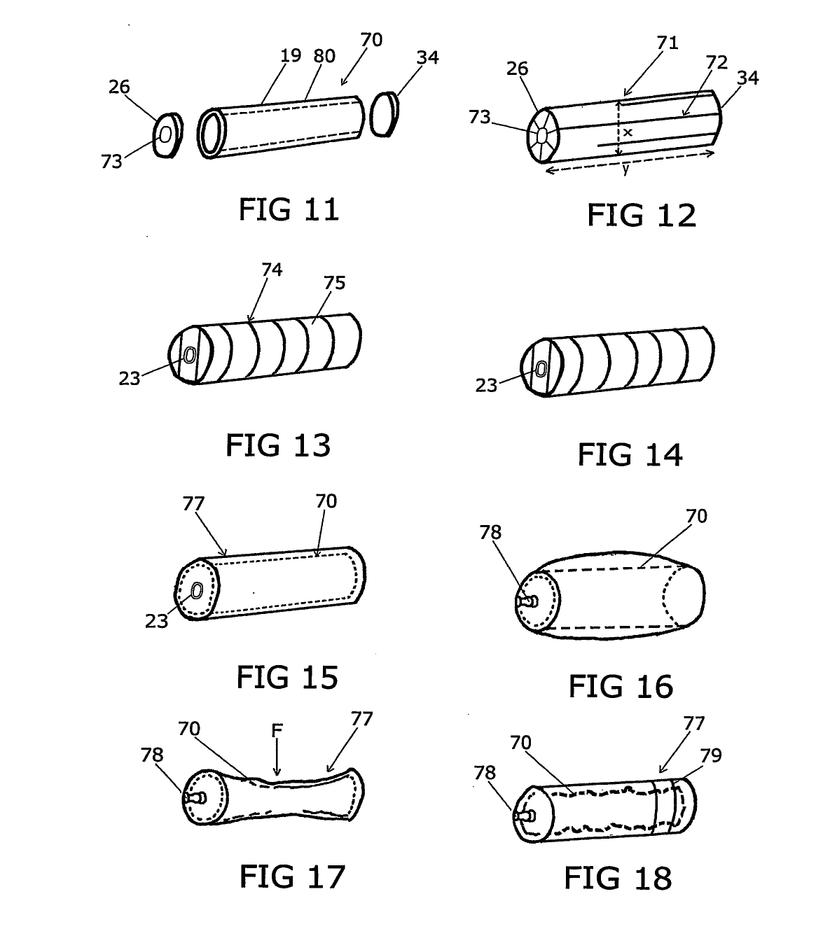

Drawing FIGS. 11-18 show the process steps of manufacturing a pneumatic plug utilizing a sacrificial core or inner mold. A cylindrical mandrel assembly 70 is shown comprised of a cylindrical core 19 with circular end members 26 and 34, i.e., metallic end plates. The end member 26 is shown to have an aperture 73 which is constructed and arranged to receive bulkhead 23 constructed to receive an inflator member 78. The bulkhead 23 may also be utilized to manipulate the mandrel assembly 70 during the process steps of manufacture. The cylindrical core 19 of the mandrel assembly 70 is constructed and arranged to act as a sacrificial inner mold having an outside diameter “x” and a length “y”. Layers 72 of an elastomeric composition, such as rubber, are layered onto the mandrel assembly 70 up to a specified thickness. Reinforcement cording is preferably sandwiched between inner and outer elastomeric layers as will be further described. An exterior or outer mold 74 is provided to hold the elastomeric layers onto the mandrel assembly 70. The outer mold 74 may be comprised of a series of flexible tape wraps, i.e., nylon. The tape composition preferably shrinks a small percentage, i.e., 3-5%, when heated. After curing at approximately 300-325° F. (148.9-162.8° C.) in an oven for approximately 2 hours the exterior mold 74 is removed from the cured body 77. After installation of an inflator member 78 in aperture 73, the plug body 77 is expanded to separate the walls of the plug body from the inner mold 70, which remains within the finished plug 77. Alternatively, a metal outer mold may be used with the layered structure on core 19. During curing of the elastomeric material in the metal outer mold, air may be introduced into the plug body structure to separate the curing body from the sacrificial core 19.

The process of manufacture shown in the drawing FIGS. 11-18 comprise the following process steps:

a) a cylindrical core structure 19 formed of cardboard or the like, having a specified O.D. is cut to a specified length; circular metallic ends 26 and 34 or, alternatively, metal end plates 56 with a connecting conduit 66 are positioned in the core ends to thereby form an inner mold or mandrel assembly 70 (FIGS. 11 and 12);

b) the inner mold (core structure and core ends) is wrapped with layers of natural rubber sheets 71 and reinforced cording up to a specified thickness (FIG. 12);

c) the body of rubber layers are wrapped and secured with tape 75, (i.e., nylon tape) which shrinks, i.e., 3% when subjected to heat to provide an outside mold 74 (FIG. 13);

d) the molded and wrapped structure is then placed in an oven at 300-325° F. for a specified period of time, i.e., 2 hours, to cure or vulcanize the natural rubber compound (FIG. 14); alternatively, a rigid metallic outer mold may be utilized; e) the exterior mold 74, utilizing tape 75, for example, is removed from the cured plug body 77 (FIG. 15);

f) an inflator member 78 is secured in the bulkhead 23 threaded in aperture 73 of the end plate 26 of the plug body and the plug body 77 is inflated to separate the rubber plug body from the core or inner mold 70 (FIG. 16); and

g) the plug structure 77 is deflated and forces F are applied to the outside of the plug body directed at the core 19 to crush and further separate the rubber plug body from the inner core structure 19 (FIG. 17) to provide the finished plug structure 77 (FIG. 18). An exterior plug pattern 79 may be provided as a result of the exterior tape segments used during the cure of the rubber plug body.

As shown in FIGS. 4-7, 10 and 11, the elastomeric layer placement onto the core 19 may include initially coating the core 19 with a suitable adhesive 80, such as a rubber cement to aid in the proper lay up of the elastomeric layers onto the core 19. For example, initially, an inner natural rubber layer 20 having a thickness of approximately 0.065-0.085 inches (0.1651-0.2159 cm) may be placed over the core 19 or inner mold. Next, a corded or weaved layer 21 comprising nylon, Kevlar or like reinforcing fibers may be positioned on top of the first layer 20. Preferably, the cording or fiber weave is unidirectional and extends along the length over the entire body of the plug and terminating generally at the centers of the opposing end plates 26 and 34. Finally, an outer layer 22 of elastomer, i.e., natural rubber, is placed over the cording, weaved or reinforced fiber rubber layer 21 to provide a sandwiched layer structure. The overall thickness of the rubber body may be in a range of 0.225-0.250 inches (0.5715-0.635 cm) for example.

The nylon tape 75 or heat tape used as the exterior flexible mold (FIG. 13) is preferably a composition that withstands a temperature of at least 325° F. (162.8° C.) and which shrinks approximately 3-5% at such temperature.

The core structure 19 which is used sacrificially, is preferably a rigid structure, i.e., cardboard, or the like, capable of supporting a lay up of materials, a temperature of approximately 325° F. (162.8° C.) and able to withstand radially directed forces as a result of the shrinkage of the exterior mold tape 75 during curing of the plug body (FIG. 14). Further, the core structure 19 is preferably crushable by an external force so that the core can be separated from the plug body after curing.

As shown in FIG. 11, one of the metal end plates 26 is preferably constructed with at least one aperture 73. A bulkhead 23 may be positioned behind and into the aperture 73 for subsequently receiving an inflator device 16. As shown in FIGS. 8-10, an aperture in plate end 56 may be utilized with a flowthrough conduit 66 which passes through the interior of the plug body and extends between the end plates 56. A second aperture 68 in the end plate 56 is provided to receive inflator member.

As further shown in FIG. 3, the bulkhead 23 is shown attached to the inner side of plug end member 12. The aperture in bulkhead 23 is designed to receive inflator member 16, (i.e., by threading), however, the threaded aperture of the bulkhead 23 may also be utilized to manipulate the core and plug body during manufacture. FIG. 3 further shows hose portion (i.e., rubber hose portion) 25 having apertures 42 and attached to the bulkhead 23. The latter structure permits the ingress and egress of air through hose portion 25. This arrangement assures proper airflow in the event that a portion of the crushed core may impede airflow with respect to inflator 16.

In summary, the invention relates to expandable plugs, such as pneumatic plug structures, and to a method of manufacturing pneumatic plugs, i.e., multi-size plugs for use in sealing 4-8 inch (10.16-20.32 cm), 8-16 inch (20.3240.64 cm), 12-24 inch (30.48-60.96 cm) and 24-48 inch ID pipes (60.96-121.92 cm). The pneumatic plugs are preferably constructed of rubber and reinforcement layers, have an inflator member and may comprise metal end plates having a flow-through conduit. Importantly, a sacrificial core structure or inner mold is used in the manufacturing method and the core remains in the plug after completion. However, the core does not become an integral part in the use of the completed plug structure.

As many changes are possible to the expandable plug embodiments and methods of this invention, utilizing the teachings thereof, the description above and the accompanying drawings should be interpreted in the illustrative and not the limited sense.

That which is claimed is:

1. An expandable device for sealing a pipeline, comprising:
a) a sacrificial core structure;
b) an elastomeric body member surrounding said sacrificial core structure and forming a plug structure having opposing ends; and
c) fluid ingress and egress means accessible to one end of said elastomeric body member, said fluid ingress and egress means further having a conduit extending into the interior of said sacrificial core, whereby upon the inflation of said elastomeric body member, said body member is at least partially separated from said sacrificial core structure.

2. The expandable plug device of claim 1, wherein said sacrificial core is a cardboard tube.

3. The expandable plug device of claim 1, wherein said opposing ends of said elastomeric body member each include a metal plate.

4. The expandable plug device of claim 3, wherein one said end of said body member is the inflation end of said plug device and wherein said metal plate of said inflation end includes a bulkhead structure having opposing ends and including an inflation valve member mounted to one end thereof and wherein said conduit extends from the opposite end of said bulkhead, said conduit further being a flexible tubular structure having a plurality of apertures.

5. The expandable plug device of claim 1, wherein an absorbent layer is positioned on the outside of said elastomeric body member and wherein a curable pipeline sealing composition is impregnated in said absorbent layer.

6. The expandable plug device of claim 1, wherein an internal bypass conduit is positioned between said opposing ends of said elastomeric body member.

7. The expandable plug device of claim 1, wherein said elastomeric body member is comprised of a cured layered body structure including rubber and rubber coated Kevlar.

8. The expandable plug device of claim 1, wherein said plug device is constructed and arranged to seal a specified pipeline diameter range and wherein said diameter range is selected from the group of diameter ranges consisting of 4-8 inches (10.16-20.32 cm), 8-16 inches (20.32-40.64 cm), 12-24 inches (30.48-60.96 cm) and 24-48 inches (60.96-121.92 cm).

9. An expandable plug device for a pipeline, comprising:
a) a sacrificial core structure;
b) a reinforced elastomeric body member surrounding said sacrificial core structure and forming a plug structure having opposing ends; and
c) fluid ingress and egress means accessible on one end of said elastomeric body member, whereby upon the inflation of said elastomeric body member, said body member is at least partially separated from said sacrificial core structure.

10. The expandable plug device of claim 9, wherein said sacrificial core structure is a cylindrical cardboard tube, wherein an internal bypass conduit is provided through said cardboard tube, wherein said reinforced elastomeric body member includes a reinforcing layer having opposing ends, wherein a rigid ring is provided at each opposing end and wherein said opposing ends of said reinforced elastomeric body member are folded about the respective rigid rings.

11. A process of manufacturing an expandable plug comprising:
a) providing a sacrificial core structure;
b) wrapping said sacrificial core with an elastomeric material;
c) positioning and holding said elastomeric material with an exterior mold structure about said sacrificial core;
d) curing said elastomeric material;
e) removing said exterior mold structure;
f) installing a fluid ingress and egress member in said cured body structure; and
g) inflating said cured structure to separate said cured body from said sacrificial core structure.

12. The process of claim 11, wherein said sacrificial core provided is constructed of a tubular cardboard material.

13. The process of claim 11, wherein forces are applied to the exterior of the cured cylindrical body structure to thereby crush and deform said sacrificial core structure to separate said cured body from said sacrificial core structure.

14. The process of claim 11, wherein an internal by-pass conduit is positioned in said sacrificial core.

15. The process of claim 11, wherein metallic plates are provided on the ends of said sacrificial core structure, wherein said elastomeric material provided comprises natural rubber and wherein said curing step comprises vulcanizing said natural rubber.

16. The process of claim 11, wherein the step of positioning said elastomeric material about said sacrificial core with an exterior mold structure comprises wrapping nylon tape about said elastomeric material.

17. A method for manufacturing an expandable plug comprising:
a) providing a sacrificial core structure;
b) wrapping an elastomeric material about said sacrificial core structure;
c) wrapping a flexible tape about said elastomeric material;
d) curing the wrapped elastomeric structure of step c);
e) removing the flexible tape from the elastomeric structure; and
f) separating the sacrificial core structure from the elastomeric structure.

18. The method of claim 17, wherein end plates are provided and placed against the open ends of the sacrificial core structure and wherein the wrapping of the elastomeric material in step b) includes wrapping of reinforced cording material.

19. The method of claim 17, wherein the flexible tape used in step c) is of the type which shrinks approximately 3% when subjected to heat.

20. The method of claim 17, wherein the elastomeric material provided includes a natural rubber sheeting and wherein the curing step d) involves heat between approximately 300-325° F. (148.9-162.8° C.) for approximately 2 hours.

21. The method of claim 18, wherein a fluid ingress and egress member is installed in one said end plate and wherein the separating step f) includes inflating the elastomeric structure.

22. The method of claim 17, wherein the separating step f) includes crushing the sacrificial core structure.
